(19) United States
(12) Patent Application Publication
(10) Pub. No.: US 2007/0002702 A1
(43) Pub. Date: Jan. 4, 2007

(54) ABERRATION CORRECTING METHOD

(75) Inventors: Hsin-Ping Cheng, Hsinchu (TW); Jui-Cheng Lee, Hsinchu (TW); Wen-Chun Hsu, Hsinchu (TW)

Correspondence Address: MADSON & AUSTIN;GATEWAY TOWER WEST, SUITE 900, 15 WEST SOUTH TEMPLE, SALT LAKE CITY, UT, 84101, US

(73) Assignee: Lite-On It Corp., Taipei City (TW)

(21) Appl. No.: 11/425,662

(22) Filed: Jun. 21, 2006

(30) Foreign Application Priority Data
Jul. 1, 2005 (TW) 094122440

(51) Int. Cl. G11B 7/00

(52) U.S. Cl. 369/44.23

(57) ABSTRACT

The present invention discloses an aberration correcting method for use between an optical disc drive and an optical disc. The optical disc drive includes an optical pickup head having an aberration-correcting unit and a control chipset. The method includes steps of: operating the optical pickup head in a focusing-locked and tracking-unlocked state; generating a read-back signal by projecting a laser beam to the optical disc; converting the read-back signal into a radio frequency signal and a tracking error signal by the control chipset; detecting corresponding amplitudes of the radio frequency signal or the tracking error signal at different compensation values by the control chipset; determining a target compensation value by selecting the compensation value corresponding to the maximum amplitude of the tracking error signal or the radio frequency signal; and controlling the aberration-correcting unit according to the target compensation value.

### FIELD OF THE INVENTION

The present invention relates to an aberration correcting method, and more particularly to an aberration correcting method for use between an optical disc drive and an optical disc.

### BACKGROUND OF THE INVENTION

Storage capacity is determined according to the recording density. For a purpose of increasing storage capacity of the optical disc, it is necessary to increase the recording density per unit area. Conventionally, the method for increasing the recording density includes a blue-violet laser technology, a super-resolution near-field structure (Super-RENS) technology, a multi-layer (Multi level) technology, etc. Among these technologies, the short-wavelength blue-violet laser technology is well established. By shrinking the size of optical spots on the optical recording medium, the recording density per unit area is increased accordingly. As known, spot-size scales with the ratio λ/NA, where λ is the laser wavelength, and NA stands for the numerical aperture of the objective lens used. In other words, shorter laser wavelengths and objective lenses with higher numerical apertures (NA) can shrink laser spots much smaller, thereby increasing the recording density.

Today, in views of mass production, the possible shortest working wavelength used in the blue laser diodes is about 405 nm. On the other hand, during a disc is produced by means of injection molding, the periphery portion is cooled down more quickly than the middle portion of the disc. Due to this temperature difference upon cooling, the disc is readily bent. As the numerical aperture (NA) is increased, the focal length of the objective lens is shrunk and thus the tolerance for a bent disc is limited. Theoretically, in optical recording systems, the limitation of the numerical apertures (NA) is about 0.85.

In January 2002, nine leading companies including Sony Corporation, Pioneer Corporation, Sharp Corporation, Hitachi, Ltd., Mitsubishi Electric Corporation (Japan), LG Electronics Inc., Samsung Electronics Co., Ltd. (Korea), Royal Philips Electronics (the Netherlands), and Thomson Multimedia (France) have jointly established the basic specifications for a next-generation large capacity optical disc format called “Blu-ray” disc. Starting form the phase transition type disc with 0.1 mm of protection layer, the Blu-ray disc enables the recording and rewriting capacity of up to several gigabytes (GB) of data on a single sided single layer disc using a 405 nm blue-violet laser and a high numerical aperture (NA) of about 0.85.

During recording or reproduction, due to variations in thickness of a protection layer and the doubled or multi-layered storage structures, spherical aberration occurs. The spherical aberration brings about degradation in recorded or reproduced signal. Particularly, when the numerical aperture NA of an objective lens is 0.6 or more, the aberration cannot be neglected.

In order to correct the spherical aberration, a spherical aberration corrector (SAC) was disclosed in for example U.S. Pat. No. 6,756,574, and the contents of which are hereby incorporated by reference. Referring to FIG. 1, a block diagram of the spherical aberration corrector described in the U.S. Pat. No. 6,756,574 is illustrated. The optical pickup head 1 comprises a laser light source 11, a lens 12, a beam splitter 13, an aberration-correcting unit 14, an objective lens 15, a lens 16, and a photodetector 17. The light reflected from the disc 5 is detected by the photodetector 17 and converted into an electric signal. The electric signal is processed via a signal processor 21 and generates a focusing error signal (FE) to a micro-controller 23. The micro-controller 23 operates the objective lens actuator through an objective lens driver 25 to drive the objective lens 15 upwardly and downwardly. The micro-controller 23 may adjust the relative position between the lenses 14A and 14B of the aberration-correcting unit 14 through an expander driver 27 according to the estimated compensation value to perform an aberration correction control.

Referring to FIG. 2, which is a diagram illustrating the relationship between the focusing error signal (Curve I) and the jitter values (Curve II) to different compensation values. Generally, there are two approaches used to correct the spherical aberration. In the first approach, the relation between different compensation values and their corresponding amplitudes of the focusing error signal (FE) is generated by the signal processor 21 as the Curve I depicts. As shown in Curve I of FIG. 2, before reading the disc 5, the maximum value of the focusing error signal (FE) should be previously searched in order to find out a first compensation value.

On the other hand, in the second approach, the relation between different compensation values and their corresponding jitter values or system error rates is generated by a logic circuit (not shown) after error checking and correction (ECC) as the Curve II depicts. As shown in Curve II of FIG. 2, a second compensation value is obtained when the jitter value is very close to the minimum. As known, the aberration correcting method of using jitter values is applicable to the disc having been recorded data therein rather than the blank disc. In addition, for a purpose achieving the improved correcting effect, the complexity of the logic circuit is increased and detrimental to mass production.

Moreover, the first compensation value with the maximum of the focusing error signal (FE) in the Curve I and the second compensation value with minimum of the jitter value in the Curve II fail to correspond to the same value. Consequently, the aberration correcting method by using focusing error signal is not feasible to obtain desirable correction.

### SUMMARY OF THE INVENTION

The object of the present invention is to provide an aberration correcting method of finding a target compensation value for performing feedback control by using a tracking error signal (TE) or a radio frequency error signal (RF).

The present invention provides an aberration correcting method for use between an optical disc drive and an optical disc. The optical disc drive includes an optical pickup head having an aberration-correcting unit and a control chipset. The aberration correcting method includes steps of: operating the optical pickup head in a focusing-locked and tracking-unlocked state; generating a read-back signal by projecting a laser beam to the optical disc; converting the read-back signal into a tracking error signal by the control chipset; detecting corresponding amplitudes of the tracking error signal when the aberration-correcting unit is adjusted according to a plurality of compensation values; determining a target compensation value according to the corresponding amplitudes of the tracking error signal; and controlling the aberration-correcting unit according to the target compensation value.

The present invention further provides an aberration correcting method for use between an optical disc drive and an optical disc. The optical disc drive includes an optical pickup head having an aberration-correcting unit and a control chipset. The aberration correcting method includes steps of: operating the optical pickup head in a focusing-locked and tracking-unlocked state; generating a read-back signal by projecting a laser beam to the optical disc; converting the read-back signal into a radio frequency signal by the control chipset; detecting corresponding amplitudes of the radio frequency signal when the aberration-correcting unit is adjusted to a plurality of compensation values; determining a target compensation value according to the corresponding amplitudes of the radio frequency signal; and controlling the aberration-correcting unit according to the target compensation value.

The present invention further provides an aberration correcting method for use between an optical disc drive and an optical disc. The optical disc drive includes an optical pickup head having an aberration-correcting unit and a control chipset. The aberration correcting method includes steps of: operating the optical pickup head in a focusing-locked and tracking-unlocked state; generating a read-back signal by projecting a laser beam to the optical disc; converting the read-back signal into a radio frequency signal and a tracking error signal by the control chipset; detecting corresponding amplitudes of the radio frequency signal or the tracking error signal at different compensation values by the control chipset; determining a target compensation value by selecting the compensation value corresponding to the maximum amplitude of the tracking error signal or the radio frequency signal; and controlling the aberration-correcting unit according to the target compensation value.

In an embodiment, the aberration-correcting unit is a beam expander comprised of two lenses. The two lenses can be driven to have different distance between each other corresponding to different compensation values

In an embodiment, the control chipset comprises a digital signal processor for converting the read-back signal into the tracking error signal or the radio frequency signal.

### BRIEF DESCRIPTION OF THE DRAWINGS

The above contents of the present invention will become more readily apparent to those ordinarily skilled in the art after reviewing the following detailed description and accompanying drawings, in which:

FIG. 1 is a block diagram illustrating a conventional spherical aberration corrector;

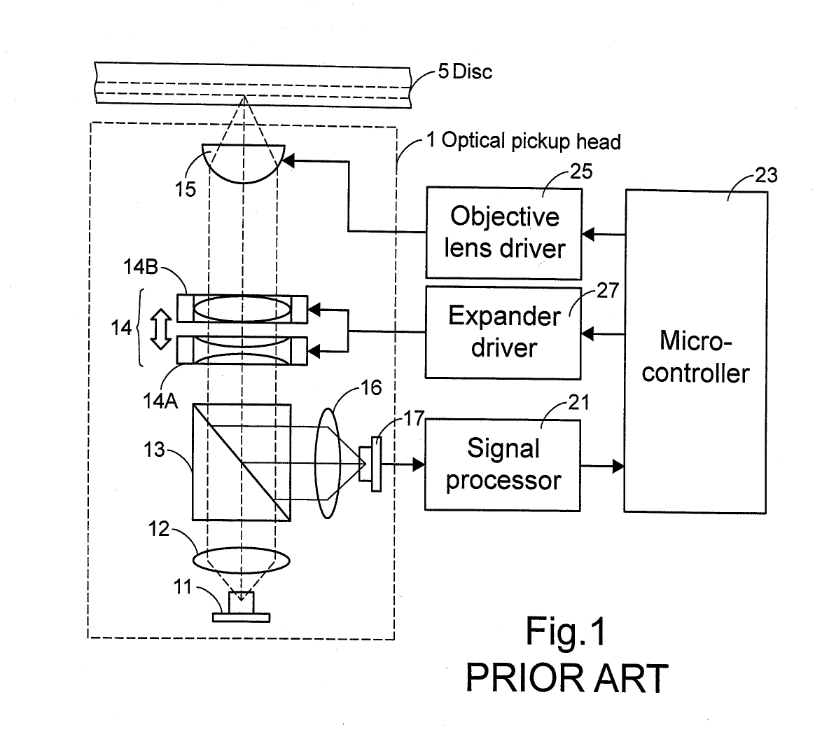

FIG. 2 is a diagram illustrating the relationship between the focusing error signal (Curve I) and the jitter values (Curve II) to different compensation values;

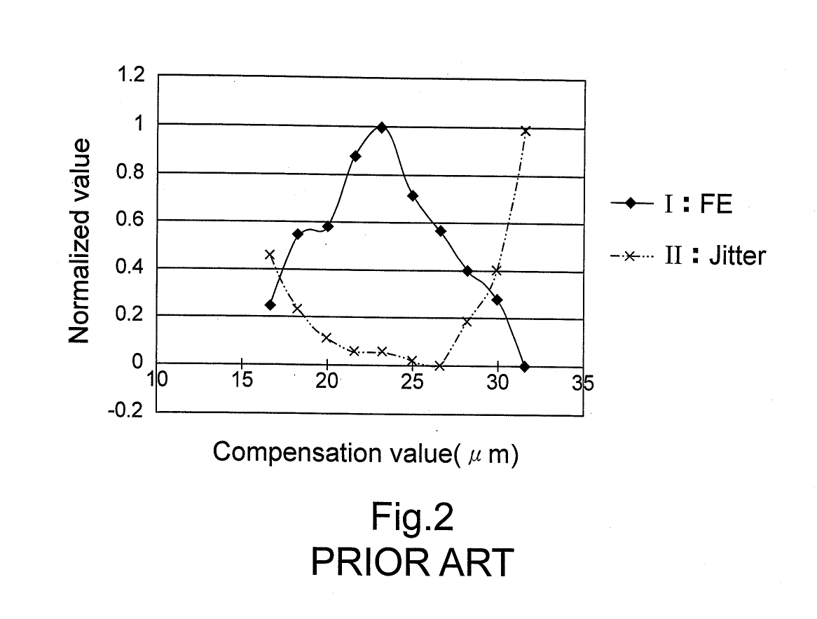

FIG. 3 is a block diagram illustrating an aberration correcting system according to a preferred embodiment of the present invention;

FIG. 4 is a diagram illustrating the relationship between the tracking error signal (Curve I), the jitter values (Curve II), and the radio frequency signal (Curve III) to different compensation values; and

FIG. 5 is a flowchart illustrating a process for correcting aberration of a disc in the optical disc drive.

### DETAILED DESCRIPTION OF THE PREFERRED EMBODIMENT

The present invention will now be described more specifically with reference to the following embodiments. It is to be noted that the following descriptions of preferred embodiments of this invention are presented herein for purpose of illustration and description only; it is not intended to be exhaustive or to be limited to the precise form disclosed.

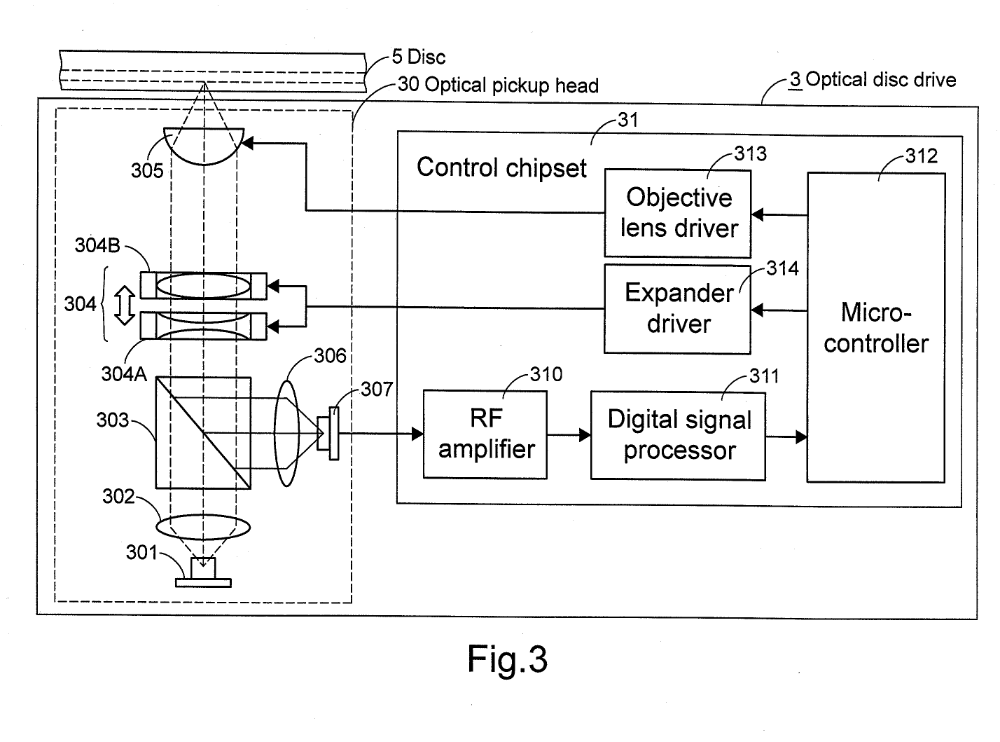

Referring to FIG. 3, an aberration correcting system for use between an optical disc drive 3 and an optical disc 5 according to a preferred embodiment of the present invention is shown. The optical disc drive 3 comprises an optical pickup head 30 and a control chipset 31. The optical pickup head 30 comprises a laser light source 301, a lens 302, a beam splitter 303, an aberration-correcting unit 304, an objective lens 305, a lens 306, and a photodetector 307. The aberration-correcting unit 304 is a beam expander comprised of two lenses 304A and 304B for correcting spherical aberration. Alternatively, the aberration-correcting unit 304 can be implemented with an LCD wave plate. The light reflected from the disc 5 is detected by the photodetector 307 and converted into an electric signal. The electric signal is processed by the control chipset 31, which includes a radio frequency (RF) amplifier 310, a digital signal processor 311, a micro-controller 312, an objective lens driver 313, and an expander driver 314. After the electric signal is processed by the control chipset 31, a tracking error signal (TE) or a radio frequency (RF) signal is generated.

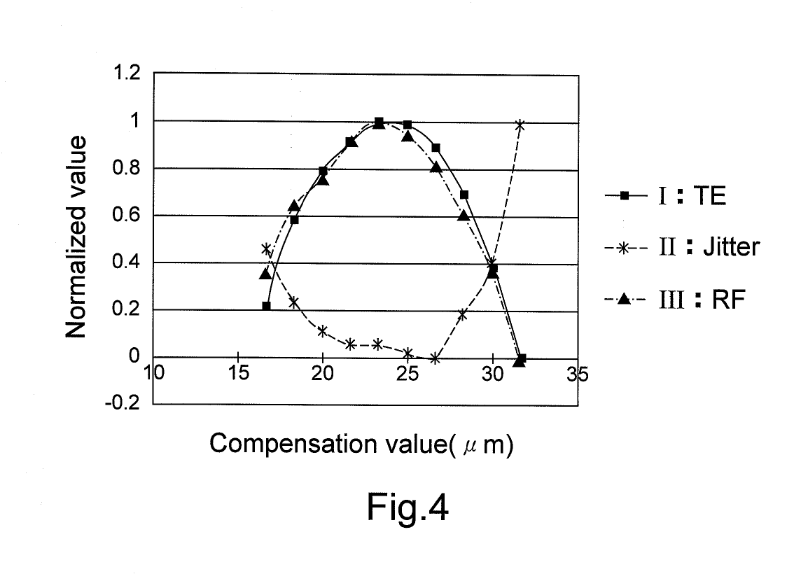

In order to find the best tracking condition, the tracking error signal (TE) and the radio frequency signal (RF) are measured while the beam expander is moved to different positions between the lenses 304A and 304B of the aberration-correcting unit 304 according to different compensation values. As shown in FIG. 4, it can be found that the amplitudes of the tracking error signal (TE) (Curve I) and the amplitudes of the radio frequency signal (RF) (Curve III) at different compensation depth values are substantially coincident with each other, and a target compensation value is obtained when the TE and RF reach their maximum.

In addition, the target compensation value and the above-mentioned second compensation value, which corresponds to a minimum of the jitter value (Curve II) are very close. In other words, before reading the disc, the maximum value of the tracking error signal (TE) or the radio frequency signal (RF) can be searched in order to find out the target compensation value. Consequently, the tracking error signal (TE) or the radio frequency signal (RF) with the target compensation value is useful as the feedback signal for controlling aberration, and the jitter value corresponding to the target compensation value will still be low enough when reading the disc.

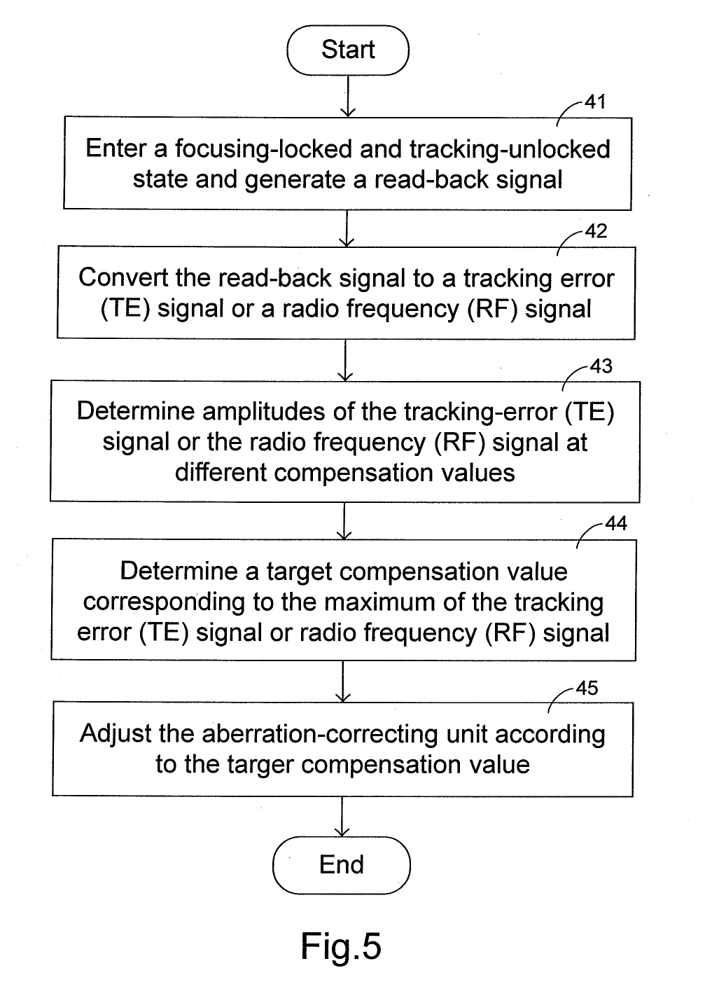

The process for correcting aberration of a disc in the optical disc drive will be illustrated in more details with reference to a flowchart of FIG. 5. Firstly, the optical pickup head 30 enters a focusing-locked and tracking-unlocked state, and generate a read-back signal by projecting a laser beam to the optical disc 5 (Step 41). Via the RF amplifier 310, the read-back signal is converted to a radio frequency signal (RF) or a tracking error signal (TE) by the digital signal processor 311 (Step 42). Subsequently, the amplitudes of the tracking error signal (TE) (Curve I) or the amplitudes of the radio frequency signal (RF) (Curve III) at different compensation values are determined (Step 43). For different compensation values, the lenses 304A and 304B are driven to have different distances between each other. A target compensation value corresponding to the maximum amplitude of the signal TE or RF can be obtained (Step 44). Afterwards, the micro-controller 312 will adjust the relative position between the lenses 304A and 304B of the aberration-correcting unit 304 through an expander driver 314 according to the target compensation value to perform an aberration correction control (Step 45).

In the above embodiment, either the target compensation value found according to the highest tracking error signal (TE) or the target compensation value found according to the radio frequency signal (RF) is fine as an index for performing feedback control when the optical pickup head 30 becoming focusing-locked and tracking-unlocked. And the target compensation value obtained by using the RF signal can do better for the optical pickup head 30 becoming focusing-locked and tracking-locked while accessing an optical disc.

From the above description, by using the tracking error signal (TE) or the radio frequency signal (RF) to correct aberration, the problems generated from using the focusing error signal (FE) can be effectively solved. The present invention can be applied to any optical disc drive such as a DVD drive or a DVD recorder. The optical disc may be single-layered or double-layered.

While the invention has been described in terms of what is presently considered to be the most practical and preferred embodiments, it is to be understood that the invention needs not be limited to the disclosed embodiment. On the contrary, it is intended to cover various modifications and similar arrangements included within the spirit and scope of the appended claims which are to be accorded with the broadest interpretation so as to encompass all such modifications and similar structures.

What is claimed is:

1. An aberration correcting method for use between an optical disc drive and an optical disc, the optical disc drive comprising an optical pickup head having an aberration-correcting unit and a control chipset, the method comprising steps of:
operating the optical pickup head in a focusing-locked and tracking-unlocked state;
generating a read-back signal by projecting a laser beam to the optical disc;
converting the read-back signal into a tracking error signal by the control chipset;
detecting corresponding amplitudes of the tracking error signal when the aberration-correcting unit is adjusted according to a plurality of compensation values;
determining a target compensation value according to the corresponding amplitudes of the tracking error signal; and
controlling the aberration-correcting unit according to the target compensation value.

2. The aberration correcting method according to claim 1 wherein the determining of a target compensation value further comprising step of:
determining the target compensation value by selecting the compensation value corresponding to the maximum amplitude of the tracking error signal.

3. The aberration correcting method according to claim 1 wherein the aberration-correcting unit is a beam expander comprised of two lenses.

4. The aberration correcting method according to claim 3 wherein the two lenses are driven to have different distance between each other corresponding to different compensation values.

5. The aberration correcting method according to claim 1 wherein the control chipset comprises a digital signal processor for converting the read-back signal into the tracking error signal.

6. An aberration correcting method for use between an optical disc drive and an optical disc, the optical disc drive comprising an optical pickup head having an aberration-correcting unit and a control chipset, the method comprising steps of:
operating the optical pickup head in a focusing-locked and tracking-unlocked state;
generating a read-back signal by projecting a laser beam to the optical disc;
converting the read-back signal into a radio frequency signal by the control chipset;
detecting corresponding amplitudes of the radio frequency signal when the aberration-correcting unit is adjusted according to a plurality of compensation values;
determining a target compensation value according to the corresponding amplitudes of the radio frequency signal; and
controlling the aberration-correcting unit according to the target compensation value.

7. The aberration correcting method according to claim 6 wherein the determining of a target compensation value further comprising step of:
determining the target compensation value by selecting the compensation value corresponding to the maximum amplitude of the radio frequency signal.

8. The aberration correcting method according to claim 6 wherein the aberration-correcting unit is a beam expander comprised of two lenses.

9. The aberration correcting method according to claim 8 wherein the two lenses are driven to have different distance between each other corresponding to different compensation values.

10. The aberration correcting method according to claim 5 wherein the control chipset comprises a digital signal processor for converting the read-back signal into the radio frequency signal.

11. An aberration correcting method for use between an optical disc drive and an optical disc, the optical disc drive comprising an optical pickup head having an aberration-correcting unit and a control chipset, the method comprising steps of:
operating the optical pickup head in a focusing-locked and tracking-unlocked state;
generating a read-back signal by projecting a laser beam to the optical disc;
converting the read-back signal into a radio frequency signal and a tracking error signal by the control chipset;
detecting corresponding amplitudes of the radio frequency signal or the tracking error signal at different compensation values by the control chipset;
determining a target compensation value by selecting the compensation value corresponding to the maximum amplitude of the tracking error signal or the radio frequency signal; and
controlling the aberration-correcting unit according to the target compensation value.

12. The aberration correcting method according to claim 11 wherein the aberration-correcting unit is a beam expander comprised of two lenses.

13. The aberration correcting method according to claim 12 wherein the two lenses are driven to have different distance between each other corresponding to different compensation values.

14. The aberration correcting method according to claim 11 wherein the control chipset comprises a digital signal processor for converting the read-back signal into the tracking error signal or the radio frequency error signal.
